(19) United States
(12) Patent Application Publication
(10) Pub. No.: US 2003/0046858 A1
(43) Pub. Date: Mar. 13, 2003

(54) Hydrodynamic fish lure

(76) Inventor: Leonard J. Meraw, Warren, MI (US)

Correspondence Address: LEONARD J. MERAW, 31733 BELLEAU DR., WARREN, MI, 48092, US

(21) Appl. No.: 09/863,155

(22) Filed: Sep. 10, 2001

(51) Int. Cl. A01K 85/00

(52) U.S. Cl. 43/42.28

(57) ABSTRACT

The present invention is a fish lure suitable for fresh and salt-water fishing comprising a hydrodynamic body and a skirt, which conceals a treble hook. The body has a general cetacean shape, pairs of front, rear and tail fins, in addition to a top fin. The forward end of the lure's body terminates in a rounded snout just below a leader connection eyelet. The skirt comprises a triad of elongated filaments, each terminating in an individual spherical eye suitable for attracting fish species.

### BACKGROUND OF THE INVENTION

1. Field of the Invention

The present invention deals with a fish lure suitable for fresh and ocean water fishing.

2. Description of Related Art

Fish lures are utilized world wide to attract and catch a variety of both fresh and saltwater fish species. Lures range from simple single hook, camouflaged ones to multi-hook, three-dimensional fancifully painted lures. Lures can resemble other fish species, worms, crustaceans, or reptiles, e.g., frogs. Fish lures are made in a rainbow of colors, a multitude of textures and sizes, plus can be adorned with feathers and metal spinners in an effort to attract fish.

Realistic type fish lures, i.e., those having fish like features, such as, fins, eyes, and painted on scales, which conceal one or more hooks, are the subject of numerous patents.

An early example of a lure having fish like features is the subject of U.S. Pat. No. 3,445,953, issued to Dailey. His flexible body lure has a large tail fin, in addition to two adjacent fins, all of which are outer edge, weighed fins. There is also a hook projecting downward on the body.

O. Rask in U.S. Pat. No. 3,879,882 discloses another flexible body fish lure having top and bottom fins, in addition to a rudder member associated with the tail fin.

E. Goetz, Jr., in U.S. Pat. No. 4,425,730 illustrates a hydrodynamic fishing lure not having the shape of any particular living species. Rather, his lure is fashioned from a wire material.

U.S. Pat. No. 4,495,722, Hess et al, shows a fish shaped lure having a multi-strand skirt, which conceals a double fishing hook.

In U.S. Pat. No. 5,193,299, Correll et al, discloses a realistic swimming fish lure having stabilizing front fins and a flexible tail section, which moves back and forth when pulled through the water. The lure further has front eyes and a front, downward facing hook.

U.S. Pat. No. 5,491,927, Ortiz, discloses an elongated lure having a forward, interchangeable, skirt and a hook behind the skirt.

Another fin bearing lure is the subject of U.S. Pat. No. 5,661,921 issued to Mason. His lure includes multiple hook hangers.

A realistic, soft body fishing lure having a V-shaped dorsal fin, which terminates in a flattened tail is found in U.S. Pat. No. 6,041,540 issued to Potts.

Another lure somewhat resembling a fish is seen in U.S. Pat. No. 6,164,006, issued to Peterson. The lure has an interchangeable tail portion and a wide front bill.

Finally, U.S. Design Pat. No. 432,201, Firmin, discloses a, laterally, perfect fish shaped appearing lure, yet no indication of hook placement or attachment is noted.

Although the above-cited patents have common features with regard to the lures disclosed, such as, fish shapes and fins, none alone or taken together suggest or teach the lure of the present invention disclosed here following.

### SUMMARY OF THE INVENTION

The hydrodynamic fish lure of the present invention comprises a body, having a general cetacean shape, and a skirt concealing a treble hook. The body further includes pairs of front and rear fins, a top fin, and bilateral tail fins lying above the plane of both pair of front and rear fins.

The skirt, securely attached to the body, comprises a triad of elongated filaments each of which terminate in an individual spherical eye.

As the lure is pulled through the water, the shape of the body along with its fins, contributes to the hydrodynamic nature of the lure. The skirt further stabilizes the lure traveling through water, as the spherical eyes facing reward attract the attention of fish. Once a fish bites the spherical eyes and elongated filaments, the fish is caught on the treble hook concealed within the skirt.

An object of the present invention is to provide a simple hydrodynamic fish lure useful in both fresh and salt-water fishing.

Another object is to provide an economically manufacturable lure having a minimal amount of components, yet effective in attracting fish. A further object is to provide a high quality, durable lure capable of a long service life.

Yet another object is to provide a fish lure having a glossy, multicolored surface finish.

Other objects pertaining to the hydrodynamic fish lure of the present invention will be evident, to one skilled in the art of fish lures, in the detailed description of the invention.

### BRIEF DESCRIPTION OF THE DRAWINGS

FIG. 1 is a perspective view of a hydrodynamic fish lure according to the present invention.

FIG. 2 is a top plan view of the hydrodynamic fish lure.

FIG. 3 is a right side view of the hydrodynamic fish lure.

FIG. 4 is a front view of the hydrodynamic fish lure.

FIG. 5 is a rear view of the hydrodynamic fish lure.

FIG. 6 is a left side view of the hydrodynamic fish lure.

FIG. 7 is a bottom view of the hydrodynamic fish lure.

### DETAILED DESCRIPTION OF THE INVENTION

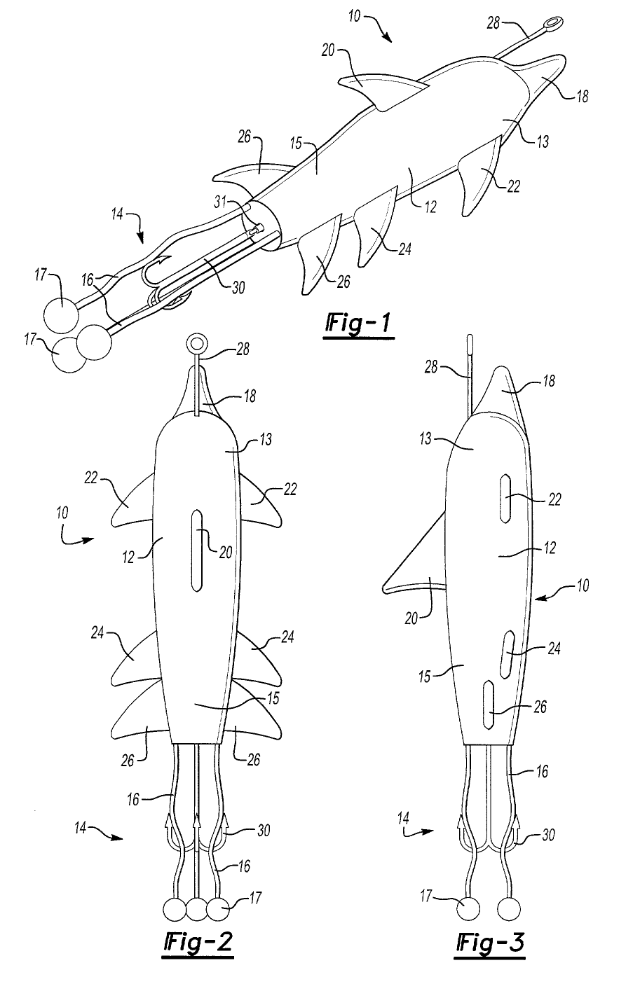

In reference to FIG. 1, a hydrodynamic lure 10 is shown comprising a body 12, and a skirt 14. The body 12 has a forward end 13, which terminates in a flattened, rounded snout 18 directly below a leader connection eyelet 28. The body 12 further has a reward end 15; onto which said skirt 14 is securely attached.

FIGS. 1 and 2 further reveal that the body 12 has a pair of front fins 22, a pair of rear fins 24, a pair of tail fins 26, and a top fin 20. Each fin is slightly curved backward to permit smooth movement through the water. Importantly, the body 12 has a cetacean shape, and not the shape of any particular fish species.

The skirt 14, seen in FIGS. 1 and 2, is made from a triad of elongated filaments 16, each of which terminates in an individual spherical eye 17. Inside of said skirt 14 is a treble hook 30 connected to the body 12 by means of a hook attachment eyelet 31 affixed to said reward end 15 of said body 12.

It is further evident that the body 12 can be said to have a top portion and a bottom portion, which would best be seen in FIGS. 3 and 6. An imaginary midline would run from the snout 18 to the hook attachment eyelet 31 and separate the body into a top portion and a bottom portion.

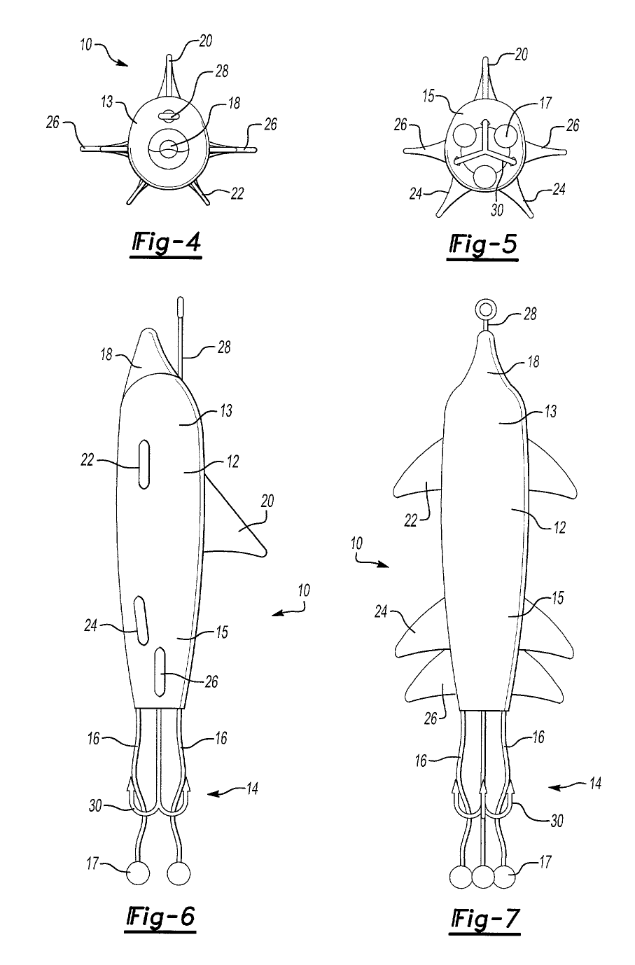

In FIG. 2, the spatial relationship of the pair of front fins 22, the pair of rear fins 24, and the tail fins 26 can be seen. Additionally, the slightly curved shape of each fin is more evident. Further, the flattened, rounded snout 18, directly below the leader connection eyelet 28, is more visible in FIG. 4.

The body 12, including the top fin 20, the pair of front fins 22, the pair of rear fins 24, and the tail fins 26, is fabricated from a single material. Preferably, this material is a urethane in nature, however, may also be other synthetic material. Additionally, the body 12 materials may be wood, or rubber. Most preferably, the material of said body 12 has a semi-buoyant character so that the lure 10 does not sink too much when pulled through the water utilizing a fishing pole.

FIGS. 3 and 6 reveal the lateral placement of the pair of front fins 22, the pair of rear fins 24, and the tail fins 26. The front fins 22 are located on the bottom portion of the forward end 13 of the body 12. The rear fins 24 are located on the bottom portion of the rearward end 15 of the body 12. The rear fins 24 follow the bottom curvature of the lure and therefore have a different angle on the body 12 than does the pair of front fins 22. The tail fins 26 lie at the imaginary midline approximately between the top and bottom portions of the body 12. The top fin 20 is disposed on the top portion of the body 12.

FIG. 4 further illustrates the relationship of the top fin 20, the pair of front fins 22, and the tail fins 26 to the forward end 13 of the hydrodynamic lure 10.

FIG. 5 illustrates the relationship of the top fin 20, the pair of rear fins 24, and the tail fins 26 to the reward end 15 of the hydrodynamic lure 10.

In FIGS. 2 and 7, said skirt 14 is clearly shown comprising a triad of elongated filaments 16. Said filaments 16 have a permanently kinked character. Further, each of the elongated filaments 16 terminates in an individual spherical eye 17. The elongated filaments 16 and spherical eyes 17 are made from the same material, and the elongated filaments 16 are permanently, securely attached to said reward end 15 of said body 12. The material of said elongated filaments 16 and spherical eyes 17 is preferably flexible and resilient in nature.

The elongated filaments 16 and spherical eyes 17 may comprise fish attractants.

Additionally, the elongated filaments 16 preferably have a bright coloration, which can be different from the spherical eyes 17. The spherical eyes 17 can be a solid color, or more preferably appear as actual eyes of a living creature when seen head on, as in FIG. 5. Various combinations of reflective colors having a glossy, matte, metallic, or luminescent finish are possible. The spherical eyes 17 are the essential feature of the lure 10 in terms of attracting fish onto the hook 30.

In FIG. 5, the position of the treble hook 30 within the elongated filaments 16 is plainly visible. The characteristic three hooks of the treble hook are equally spaced between the spherical eyes 17 within said skirt 14. Moreover, the elongated filaments 16 are rigid enough in composition to maintain this spaced arrangement seen in FIG. 5.

The body 12 preferably has a bright, multicolored decorative surface coating. Again, the color of the coating may include various combinations of reflective colors having a glossy, matte, metallic, or luminescent finish. The coloration of the body 12 may be the same as, or different from, either the elongated filaments 16 or spherical eyes 17.

When the lure 10 is pulled through water via a line and a fishing pole, the top fin 20, the pair of front fins 22, the pair of rear fins 24, and the tail fins 26, along with the cetacean shape of the body 12, all contribute to the hydrodynamic nature of the lure 10. The flattened, rounded snout 18 also is important to the hydrodynamic nature of lure 10. This means, the lure 10 will travel smoothly through fresh or salt water while elongated filaments 16 and spherical eyes 17 attract fish onto the treble hook 30 concealed within the skirt 14.

The hydrodynamic lure 10 of the present invention as disclosed and described in the foregoing text and drawings, is entirely suitable for both fresh and salt-water recreational or commercial fishing.

One skilled in the art of fish lures will understand and appreciate minor deviations in the hydrodynamic lure 10 which would fall within the scope of the present invention.

I claim:

1. A hydrodynamic fish lure, comprising:
a body having a forward end, a rearward end, a top portion, and a bottom portion, said forward end terminating in a flattened, rounded snout;
a leader connection eyelet located on the forward end of said body directly above said snout;
a pair of front fins located on the bottom portion of the forward end of said body; a pair of rear fins located on the bottom portion of the reward end of said body; a top fin disposed on the top portion of said body; a pair of tail fins bilaterally disposed on said reward end of said body at an imaginary midline delineating the top portion and bottom portion of the body;
a skirt securely attached to said reward end of said body, said skirt being formed from a triad of elongated filaments each terminating in an individual spherical eye; and
a treble hook spacedly positioned within said elongated filaments, said hook being connected to said body by means of a hook attachment eyelet.

2. The hydrodynamic fish lure of claim 1 wherein said body has a cetacean shape.

3. The hydrodynamic fish lure of claim 1 wherein said elongated filaments and said spherical eyes are formed from a flexible, resilient material.

4. The hydrodynamic fish lure of claim 1 wherein said body has a multi-colored, decorative surface coating.

5. The hydrodynamic fish lure of claim 1 wherein said elongated filaments and said spherical eyes comprise fish attractants.

6. The hydrodynamic fish lure of claim 1 wherein said front fins, said rear fins, said top fin, said tail fins, and said snout function in unison when traveling through water to contribute to the hydrodynamic nature of said fish lure.

7. The hydrodynamic fish lure of claim 1 wherein said body is formed from a flexible, semi-buoyant material.
